(19) United States
(12) Patent Application Publication
(10) Pub. No.: US 2005/0021903 A1
(43) Pub. Date: Jan. 27, 2005

(54) METHOD OF EMBEDDING PRODUCT INFORMATION ON A DIGITAL VERSATILE DISC

(76) Inventor: John Francis Baxter JR., Marco Island, FL (US)

Correspondence Address: SMITH & HOPEN PA, 15950 BAY VISTA DRIVE, SUITE 220, CLEARWATER, FL, 33760, US

(21) Appl. No.: 10/604,603

(22) Filed: Aug. 4, 2003

Related U.S. Application Data
(60) Provisional application No. 60/481,142, filed on Jul. 25, 2003.

(51) Int. Cl. G06F 12/00; G06F 12/14

(52) U.S. Cl. 711/100; 369/100

(57) ABSTRACT

A method of advertising products utilizing the standard digital versatile disc (DVD) format incorporated by virtually all home DVD players. The method includes presenting purchasing information within a DVD having video content such as movies, documentaries, music videos, and the like. A product sought to be sold is identified within the video content and viewer-selectable options generated within the menu hierarchy permit the user to obtain additional information on the product.

### CROSS REFERENCE TO RELATED APPLICATIONS

This application claims priority of U.S. Provisional Patent Application Ser. No. 60/481,142 filed Jul. 25, 2003 entitled “Method of Embedding Product Information on a Digital Versatile Disc.”

### BACKGROUND OF INVENTION

1. Field of Invention

This invention relates to a method of advertising products and services on a Digital Versatile Disc (DVD).

2. Background of Invention

DVD is a high capacity CD-size disc for video, multimedia, games and audio applications. Capacities for the read-only disc range from 4.7 GB to 17.1 GB. There are several types of DVDs. DVD-Video was launched in 1997 and has become the most successful of all the DVD formats, as it has proved to be an ideal vehicle for distributing video content from the movie industry. It can store a full-length movie of high quality video with surround sound audio on a disc the same size as a CD. DVD-ROM is set to replace the CDROM and provide a new high capacity disc format for the computer industry. New personal computers are frequently provided with DVD drives instead of CD drives. The entertainment industry has developed new games consoles (e.g. Sony's PS2 and Microsoft's X-Box), which incorporate DVD-ROM drives for more sophisticated and realistic games applications. DVD-Audio, which was launched in 2000, is gathering momentum to become the format for high quality surround sound music. Recordable formats such as DVD-RAM, DVD-RW and DVD-R are now being extensively used in PCs for computer backup and short runs of DVDs and in standalone products such as video recorders and camcorders. DVD-Video discs use only UDF (not ISO 9660) with all required data specified by UDF (Universal Disk Format) and ISO 13346 to allow playing in computer systems. The DVD-Video files must be no larger than 1 GB in size and be recorded as a single extent (i.e. in one continuous sequence). The first directory on the disc must be the VIDEO_TS directory containing all the files. All filenames are 8.3 format. All other files not included in the DVD-Video specification will be ignored by DVD-Video players.

Businesses have not been blind to the advertising possibilities enabled by DVD technology. For DVD video features, a “first play” clip can be structured wherein the user cannot advance or skip through the presentation. Copyright notices are almost always included in the “first play” clip. While it is possible to put advertising content in the “first play” clip, it would likely be annoying to the end user. Being forced to watch the same advertising content each time the DVD is placed in the player is not desirable. One advantage of DVD technology is that the end user is in control of the video presentation. They may skip ahead, pause, rewind at will.

The current DVD home players are stateless and do not support network connectivity. Ideally, advertisers would directly link subject matter in a DVD to a networked resource for conducting commercial transactions. However, in reality, such connectivity does not exist in the standard DVD player market and would likely introduce additional expense and complexity into the device itself.

Therefore, an unfulfilled need exists in the art to present advertising content within the framework of existing DVD specifications embodied in commercially available DVD players to let the end user control the presentation and Introduction of advertising content.

### SUMMARY OF INVENTION

The present invention is a method of advertising products utilizing the standard DVD ISO incorporated by virtually all home DVD players. The method can be generally summarized as presenting purchasing information within a DVD having video content such as movies, documentaries, music videos, and the like. A product sought to be sold is identified within the video content. At least one frame of the video content showing the product is captured. The frame is modified to enhance the presence of the product. The product may be emphasized in a number of ways including gray-scaling the background of the frame, leaving the product in color; blurring the background, deleting the background or solid-filling the background while leaving the product itself unmodified. An advantage of emphasizing the product in the frame is that the context in which the product appears in the movie is noted to the viewer. Another advantage of modifying the single frame is that chroma effects are not required during production. Rather, post-production editors using off-the-shelf tools such as ADOBE PHOTOSHOP may generate the effect. Yet another advantage of modifying the single frame is that the product itself may form a user-selectable button. For example, the rectangular area in which the product appears is copied, excluding the background. The rectangular area is then precisely overlayed over another image of the background so it appears as a single image. However, when the viewer movies the menu selection over the product, it is selectable with visual response over that rectangular area defined by the product. In this manner, multiple products that appear in a single frame may become user selectable in an aesthetically pleasing manner.

A menu interface is created within the frame and the resultant rectangular area forms a button associated with the product. Responsive to the activation of the button, a second menu having purchasing information for the product is displayed. The button associated with the product may also be an abstract button or text string, preferably in proximity to the image of the product within the frame.

A time code value of the frame may be recorded, the modified frame inserted at the time value and the video content paused for a predetermined wait loop while the modified frame is displayed. A plurality of reduced-sized modified frames may be presented concurrently wherein each frame is associated with a plurality of products on at least one menu. Submenus may be generated for each product to display additional detail on the associated product.

A video feature may be divided into a plurality of chapters, a motion menu background of each individual chapter is generated. The product information button is inserted over the motion menu background whereby responsive to the activation of the product information button a linked product information menu is displayed having data on the related product. A substantially transparent menu button may be placed over the motion menu background and a timeout value for the motion menu equal to the duration of the clip of the individual chapter is set whereby upon expiration of the timeout value, the substantially transparent menu button is activated by default to the next chapter in the feature playing through a second motion menu background. In this manner, visible or invisible user-selectable controls are overlaid on top of the video content where each chapter is linked to another through motion menus. Thus, the viewer experience is nearly identical to that of watching traditional video content with the additional option of jumping to submenus that are context-sensitive to the chapter of the video content in which they appear.

The invention embodied in a computer software application for authoring video menu structures on a DVD includes a product database module stored on a computer accessible medium, the product database module including at least a product identification data field and a time code data field. The database module may connect to a local or remote data source. For enterprise-wide authoring, MICROSOFT SQL, ORACLE9i, IBM DB2 or similar product offerings may store the data in tables. A menu generation module communicatively coupled to the product database module generates a menu structure responsive to the presence of data fields in the product database module whereby product information contained within a submenu is user-accessible substantially contemporaneous to a product's appearance in the video content. While it is possible to generate a separate motion menu for each product that appears, this method might not be preferred. Fragmenting the video content into numerous motion menus may result in short pauses during which the disc seeks the next menu content. To viewers, the presentation will appear to stutter. Rather, a preferred embodiment of the invention calls for a grouping module communicatively coupled to the menu generation module whereby products that appear between predetermined time code values are grouped into at least one submenu. This permits a single motion menu to span a greater length of time whereby the perception by the viewer is that the presentation is seamless and fluid.

The software application may include a frame capture module communicatively coupled to the product database module whereby at least one still frame showing the product is recorded based on the time code data field. The at least one still frame showing the product is inserted in the at least one submenu.

The product database module may also include a start time code data field and an end time code data field for each product appearing in the video content. A product clip capture module is communicatively coupled to the product database module whereby a video clip of the product is extracted from the video content and inserted into the at least one submenu, the span of the video clip is defined by the start time code data field and the end time code data field. Preferably, the video clip of the product inserted into the at least one submenu is a user-selectable button, the selection thereof linking to another submenu containing additional product information.

A chapter segregation module may be included which is communicatively coupled to the menu generation module, the chapter segregation module defining the predetermined time code values within which products are grouped whereby each predetermined time code value pair defines a motion menu background, at least two or more user-selectable buttons overlaying a first menu having a motion menu background defined by a first pair of predetermined time code values, responsive to the selection of a first button, the DVD is advanced chronologically to a second menu having a motion menu background defined by a second pair of predetermined time code values, alternatively, upon the selection of a second button the DVD is advanced to a submenu containing product information. A first timeout value is generated equal to the length of the first menu, upon expiration of the first timeout value the DVD is advanced to the second menu.

Another embodiment of the invention may include a frame capture module communicatively coupled to the product database module whereby at least one still frame showing the product is recorded based on the time code data field. A magnetic lasso selection module communicatively coupled to the frame capture module may be provided, the magnetic lasso selection module adapted to select and emphasize the product against the product's background. The product's background may be gray-scaled, blurred or filled to emphasize the product (foreground).

Particularly in a feature films, there may be hundreds of brand name products or services clearly visible throughout the various scenes. In an embodiment of the invention, a remote client interface is provided. The interface receives product and time code data which is communicatively coupled to the product database module. The remote client interface is preferably a platform independent device such as a web browser to permit remote entry of product and time code data. The remote client interface may permit upload of product information including graphics and video. Preferably, the graphics are compliant with the dimensions and resolutions commonly used in the discs (i.e., 720 by 480 pixels and 72 dpi). In addition, the video is preferably MPEG-2. A server-side process may be employed to validate the compatibility of the uploaded files and reject those that do not meet the appropriate standards. Within the remote client interface, the video content may also be presented to assist the end user in finding the correct time code. The time code data may be overlaid directly onto the video content displayed through the remote client interface. In addition, a preferred embodiment of the interface may split the video content into distinct chapters prior to viewing. This would alleviate bandwidth limitation issues and permit an end user to work with one chapter while downloading another over a remote data connection. Video content delivered to the remote client interface may be heavily watermarked to discourage pirating and recreational viewing.

The present invention may be utilized to generate pre-production revenue for video content such as major motion pictures, documentaries, music videos, sports programs and the like. Advertisers and sponsors take a more active role prior to the initiation of the project rather than concurrently with production and/or post-production. An advantage of formulating the boundaries of product use at the pre-production stage is that the creative director and sponsor can determine, prior to footage being shot, the framework in which products may appear in the video content. This permits the creative director to maintain his or her artistic freedom while assuring the product advertiser that its objectives will be met as well.

When generating pre-production revenue, a product placement algorithm is used. The algorithm Includes presence values which are calculated from time duration, brand name visibility and product interaction with the story line or action. Equation 1 Provides:

$${\sum }_{n} ( \frac{d \times 10000}{rt} ) ( v ) ( i ) .$$

where d is the duration of the product image shown In the video content in seconds, rt is the total runtime length of the video content in seconds, v is the visibility of the brand name on a scale between one and ten, and i is the production interaction with the story line or action on a scale between one and ten. If the brand name is not at all visible but the product itself is placed in the video content, then the v value would be one. If the product brand name was clearly shown in a close-up or full-screen shot of the product, the v value would be ten. If the product is used as a background prop and does not interact with the story line of the video content, then the i value would be one. If the product is mentioned, manipulated or otherwise significantly plays a role in the video content then the i value may move towards a maximum value of ten. In Equation 1, n is the number of times the product appears in the video content.

An advantage of generating a product placement algorithm is that both content producers and advertising sponsors have a preexisting framework to negotiate revenue generation. In addition to the pre-production revenue, additional payments may be contingent on the actual sales of the forthcoming DVD containing the video content. A sales threshold vale may also be employed whereby a predetermine quantity of discs must be sold prior to sale-based payments being due.

The present invention also discloses a method of distributing DVDs having variable advertising content. The process includes establishing an array of demographic data on an individual viewer, receiving a request for a video title from the viewer, automatically inserting advertising content targeted to the demographic data of the viewer, recording the video title and targeted advertising content on a DVD and distributing the disc to the viewer. The advertising content recorded on the disc and delivered to the viewer is recorded on a storage means so that advertising content previously distributed to the viewer is excluded in the next disc delivery. An advantage of this method is that video content that was created years ago, or even recorded onto disc years ago may be delivered with timely and targeted advertising content. The advertising content may include services and products, including, but not limited to, theatrical trailers for additional motion picture productions.

Another embodiment of the invention includes the steps of retrieving past requests from the storage means, categorizing the type of requests into a genre, selecting an array of related video titles within the genre and recording theatrical trailers to the genre with the video title on the DVD. Theatrical trailers previously distributed to the viewer may be excluded from the array.

### BRIEF DESCRIPTION OF DRAWINGS

For a fuller understanding of the nature and objects of the invention, reference should be made to the following detailed description, taken in connection with the accompanying drawings, in which:

FIG. 1 is a diagrammatic view of a standard DVD menu hierarchy.

FIG. 2 is a diagrammatic view of two embodiments of the invention described herein.

FIG. 3 is a computer screen capture of a software application interface for time-coding products within a video presentation.

FIGS. 4-5 are computer screen captures of a software application interface for enhancing the presence of a product within a video frame.

FIG. 6 is a computer screen capture of a software application interface for generating product-linked chapter titles as motion menu backgrounds.

FIG. 7 is a diagrammatic view of an embodiment to the invention providing a menu-accessible hierarchy for obtaining additional information on a product.

FIG. 8 is a diagrammatic view of an embodiment to the invention that inserts a still frame of a product within a wait loop during the video presentation.

FIG. 9 is a diagrammatic view of an embodiment to the invention providing a menu from which a plurality of products may be investigated.

FIG. 10 is a diagrammatic view of an embodiment to the invention describing how motion menu backgrounds are generated with linked product information.

FIG. 11 is a diagrammatic view of an embodiment to the invention providing a remote client interface for entering product and timecode information.

FIG. 12 is a diagrammatic view of an embodiment to the invention describing a business method for generating pre-production revenue.

FIG. 13 is a diagrammatic view of an embodiment to the invention providing a method for demographically targeting advertising on DVD distributions including maintaining historical records on a viewer's preferences.

### DETAILED DESCRIPTION

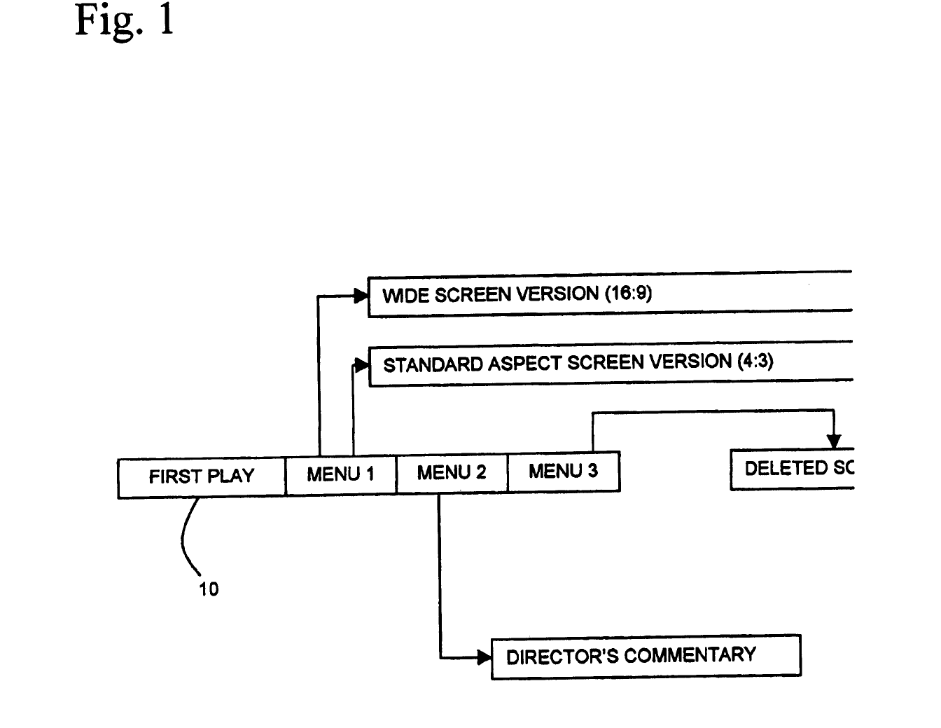

FIG. 1 illustrates a typical menu structure for a DVD. A first play segment 10 is generated to include an opening montage pertaining to the film content, film trailers, advertisements from the production source (i.e., a movie studio) and a copyright warning against unauthorized duplication. During the first play segment 10, viewers are restricted from advancing through the content. While this insures that end users view the information, it may also become annoying since the first play segment 10 is run every time the DVD is loaded into the player. Accordingly, is generally not desirable to insert lengthy first place clips and thus, they are not optimal as an advertising vehicle.

Multiple menus 1-3 provide options prior to the initiation of the featured video content. Such options may include selecting a screen aspect ratio, viewing deleted scenes from the original product or viewing the feature with the director's commentary dubbed over the soundtrack.

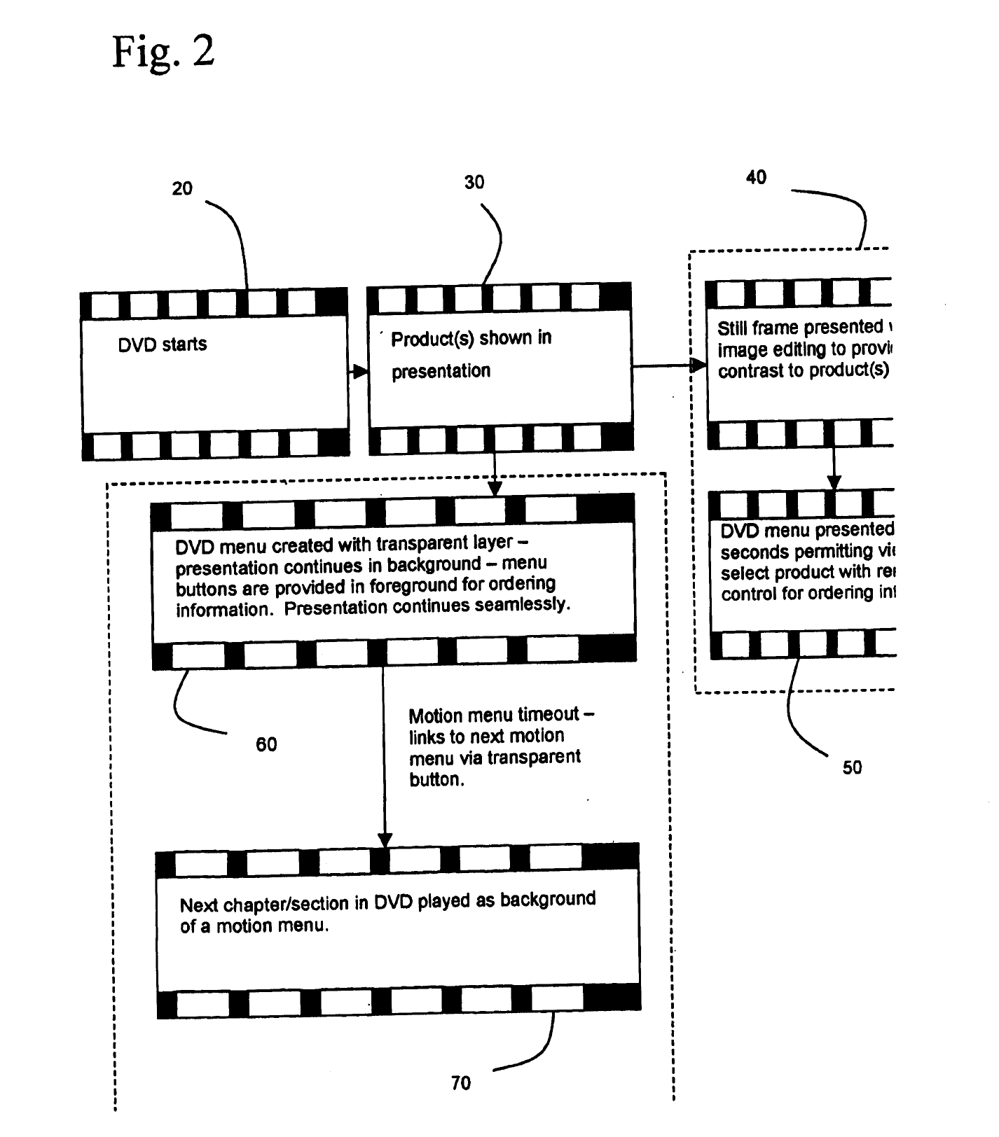

The general method of the invention is shown in FIG. 2 in several steps. In the first step, the DVD starts 20, goes through the first play and any preliminary configuration menus. The product is then shown in the presentation 30. At this point there are two embodiments of the invention that may be employed. In the first embodiment of the invention, a still frame is presented 40, the still frame image is edited to provide high-contrast or enhanced presence to the product or products. A frame wait loop 50 holds the still frame for n seconds. Preferably, the still frame image 50 is overlaid with product information in the form of text or additional graphics. It is also preferred that the end user have the ability to choose whether the still frame images appears while viewing the video presentation. This may take the form of a selection to either “view the movie”or “shop the movie.” By doing so, the video presentation maintains its artistic integrity without interruption if desired.

An alternative embodiment is shown in FIG. 2 wherein a DVD motion menu is generated 60. Motion menus are frequently seen as ten to thirty second loops in the beginning of DVDs. However, under the present invention, the motion menu is extended out to the entire length of the video presentation, or more likely, an individual chapter of the video presentation. Buttons are provided in the foreground of the motion menu. The buttons should be unobtrusive and may be semi-transparent so as not to detract from the video presentation. However, by having the buttons available, viewers may navigate to additional menus that are context-sensitive to the video presentation being viewed. A timeout value for the motion menu is set equal to that of the video presentation length played through the menu. Upon expiration of the timeout value, the next chronological chapter 70 of the video presentation is presented whereby the entire video presentation appears in continuity but is actually an array of motion menus which timeout values sequentially links them together.

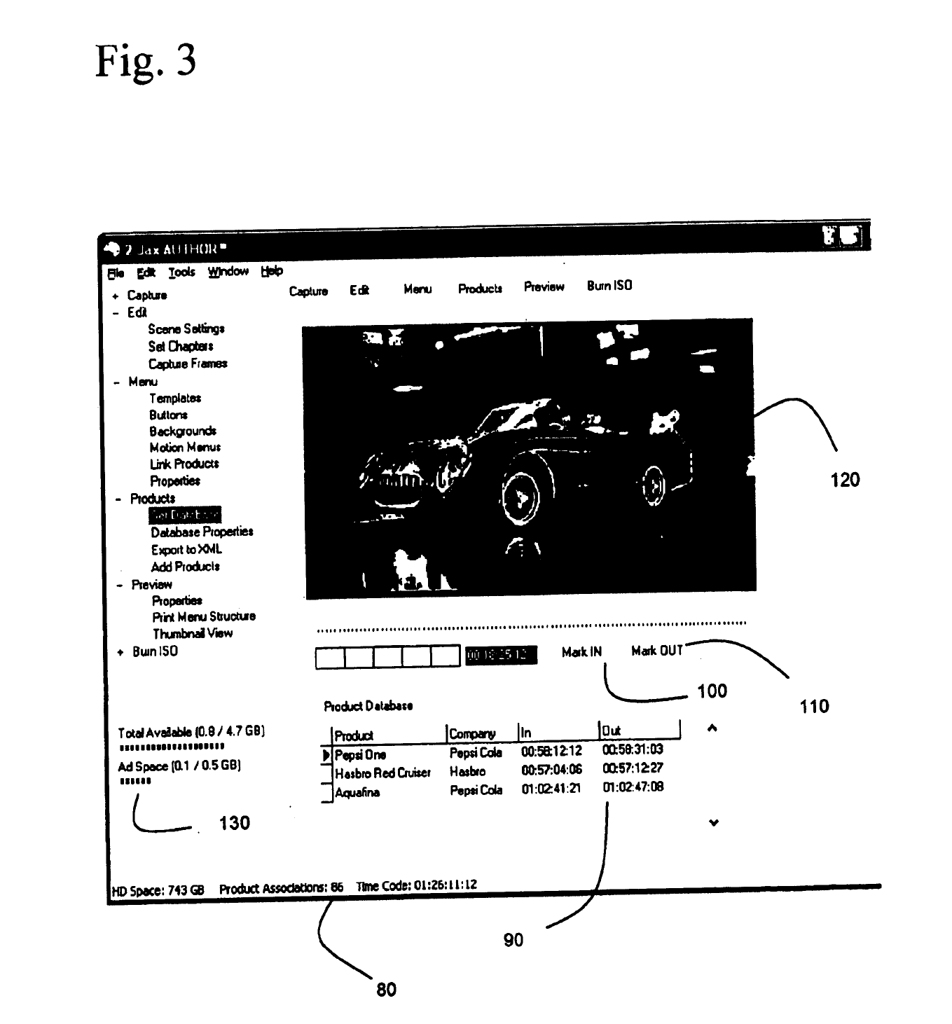

FIG. 3 is an embodiment to the present invention in a Microsoft Windows®-compatible software application 80. As seen from the application program interface, a database 90 displays time code data for a plurality of products. The time code data is marked in 100 and out 110 by viewing the video content on a display window 120. A primary key for each product in the product database 90 is linked to additional product information content whereby the application 80 generates submenus and links automatically from the database 90. An ad space indicator 130 is provided to monitor the amount of data space occupied by the product information content. Under one embodiment of the invention, the product advertiser or sponsor may pay for product information insertion in the DVD based on the amount of data its products occupy on the disc. For example, still frame images, 720 by 480 pixels in dimension and 72 dpi (dots-per-inch) might require only 100 kilobytes of space, while a ten second promotion of the product might require 30 megabytes of space. An advantage of the present invention is that menus generated from database records permit comprehensive and timely updates of the DVD content. Accordingly, as new product information is available, new DVD ISO images may be rapidly created to suit distribution needs.

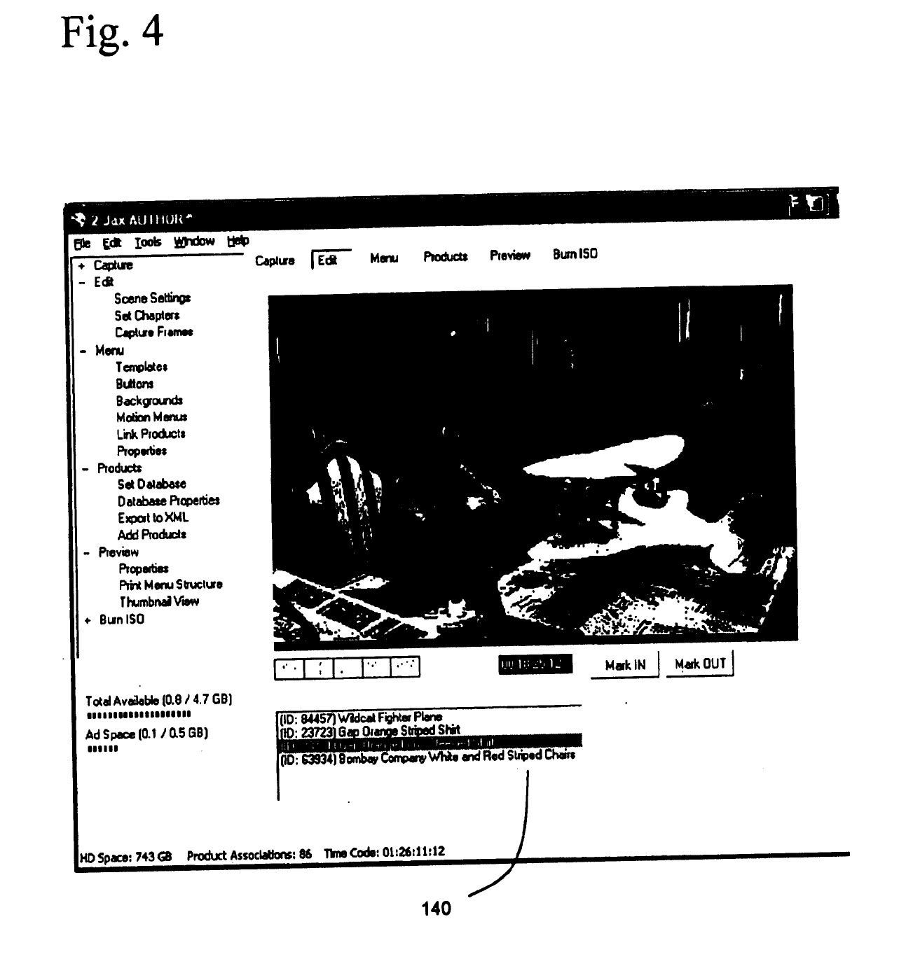

In FIG. 4 a still frame is edited to enhance the present of the product sought to be marketed and/or sold. A database view 140 for the frame indicates which products are available in that frame. For example, a toy plane, two types of shirts and furniture are all identifiable in the single frame. Brand names noted herein are not necessary representative of the actual products shown and are only used for illustrative purposes. In FIG. 5, the background to everything but the toy airplane is removed leaving a white space 150 over which product information on the remaining object may be placed.

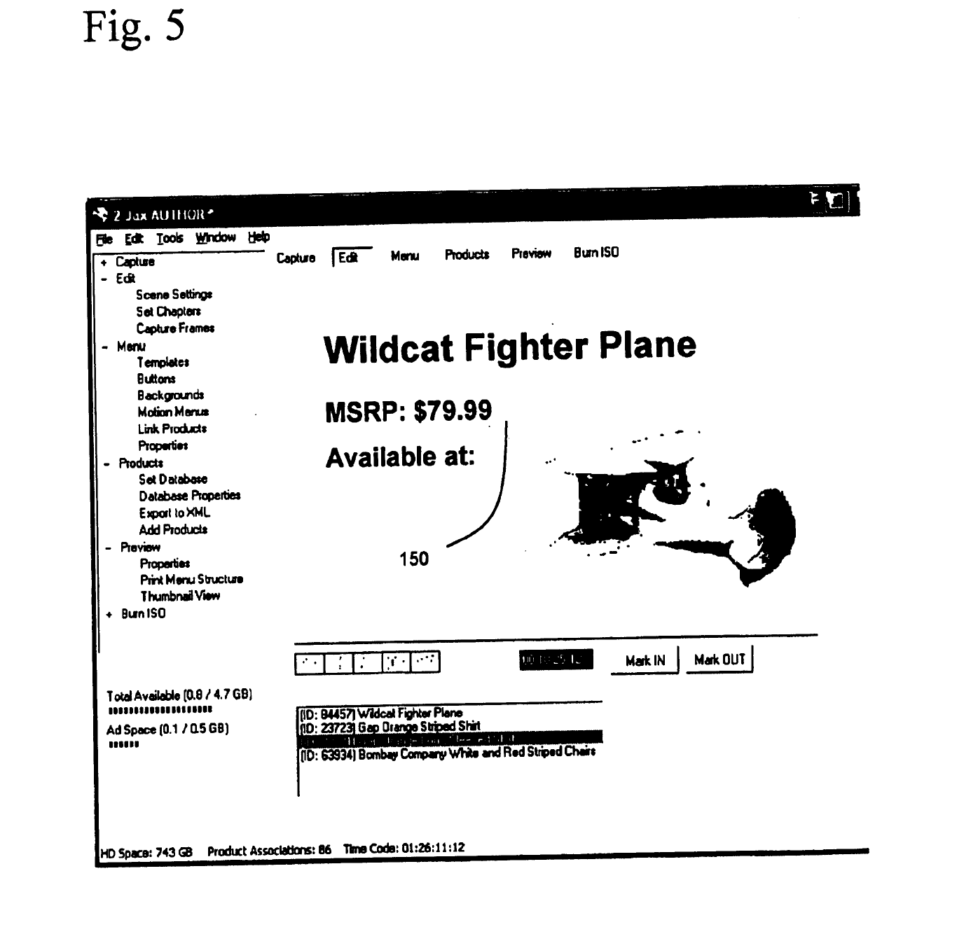

FIG. 6 illustrates the software application screen for linking various menus together. As shown on the right menu tree 160, two brand name products are featured within the first chapter of the video presentation, PEPSI®and AQUAFINA®. Upon generation of the menu structure, the first chapter is inserted into a motion menu and buttons are overlaid on the screen to link to either the “Pepsi”submenu or the “Aquafina”submenu. Should the viewer select either, additional submenus are available with sponsor content 170. However, whether the viewer enters any of these menus is entirely in the viewer's discretion. Accordingly, the viewer is not subject to intrusive advertising that would detract from the entertainment value of the original video content.

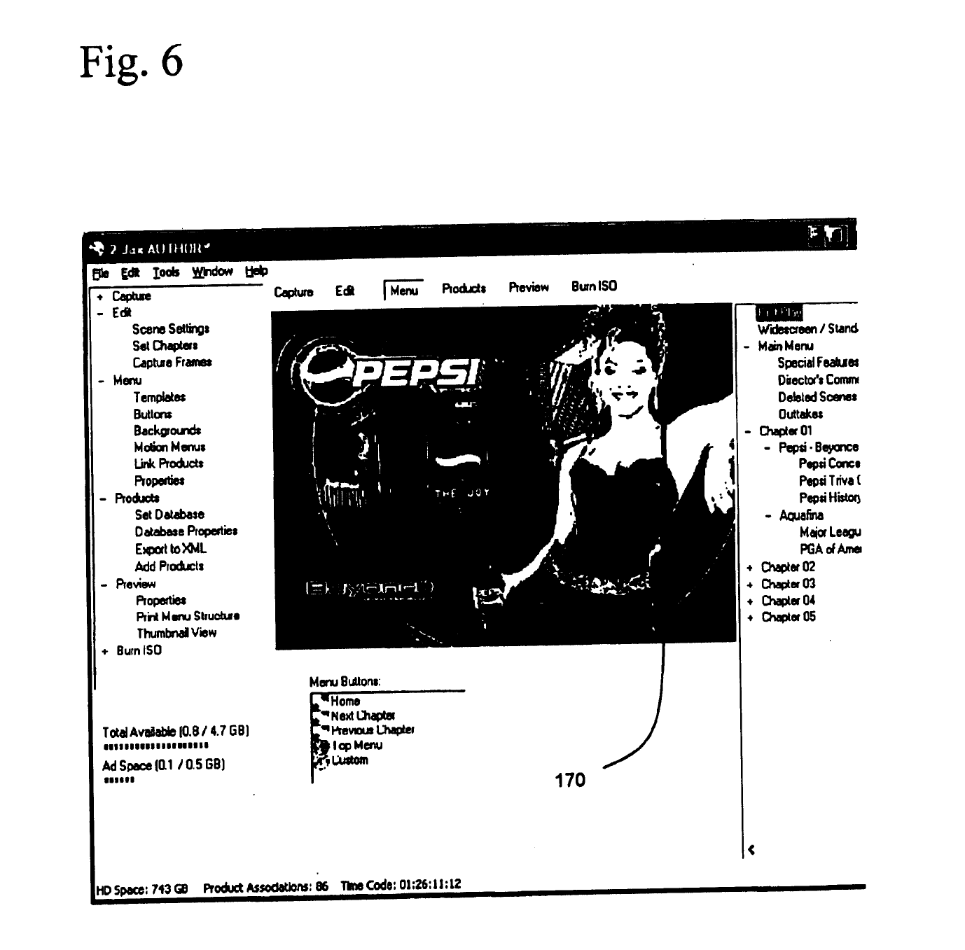

In FIG. 7, product 170 is found within video content and at least one or more frames of the product are captured 180. The presence of product 170 is enhanced 190. A first menu 200 is generated with the enhanced product 170 displayed thereon. A second menu 210 is available responsive to selection of a button on the first menu 200 to show additional information on product 170.

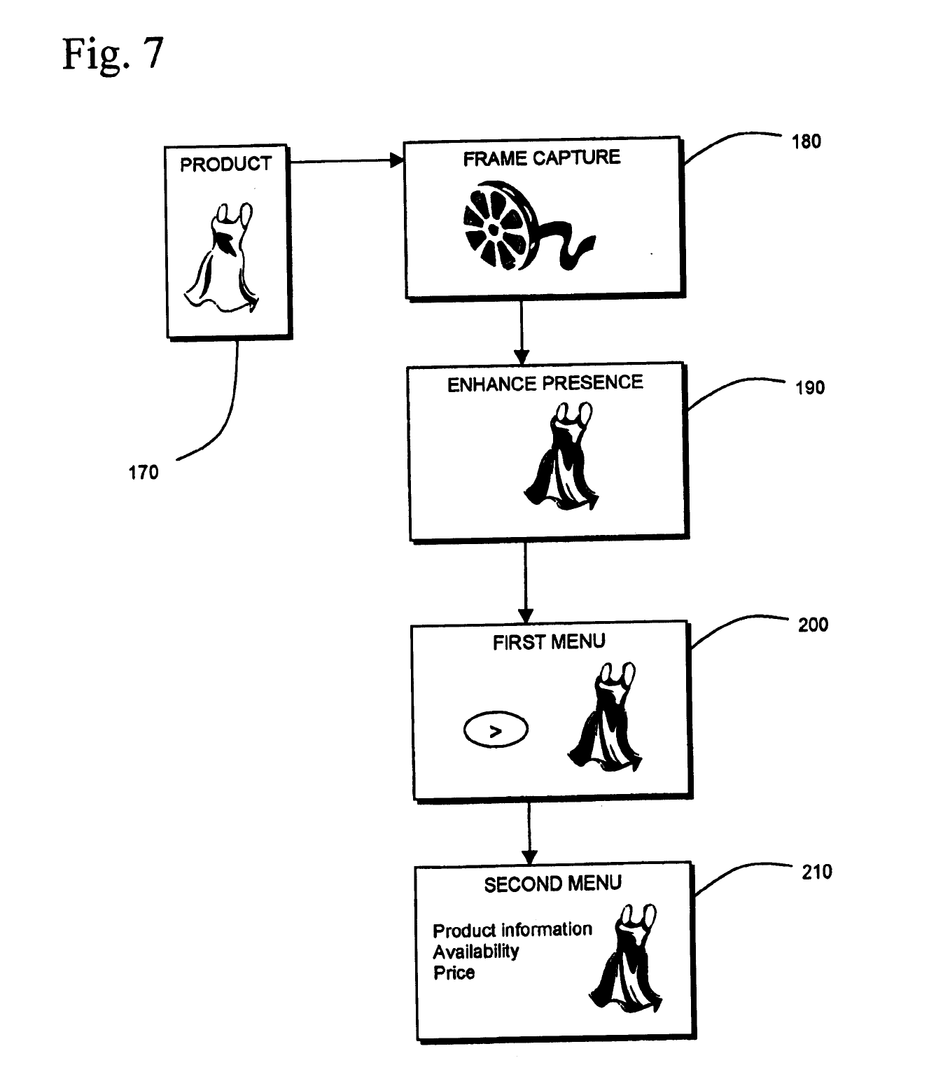

In FIG. 8, product 170 is inserted 220 into the time line of the video presentation for a predetermined wait loop. The video presentation is paused wherein viewers are given an opportunity to learn additional information about the product. It is preferred that the user voluntarily enable this feature under a SHOP MOVIE™ selection option on the DVD menu hierarchy.

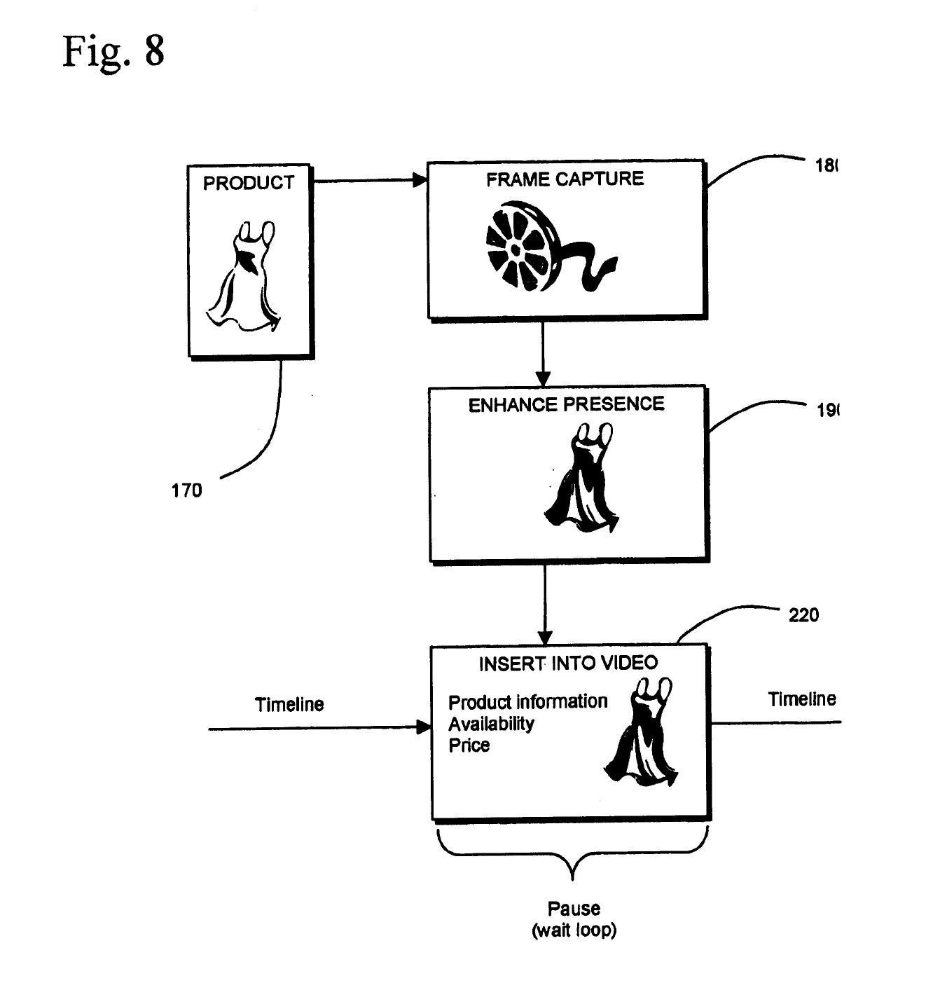

In FIG. 9 multiple products 170 are presented on a single menu 230 wherein the viewer may select an Individual product to view another submenu dedicated to the individual product and supplying additional information on the individual product.

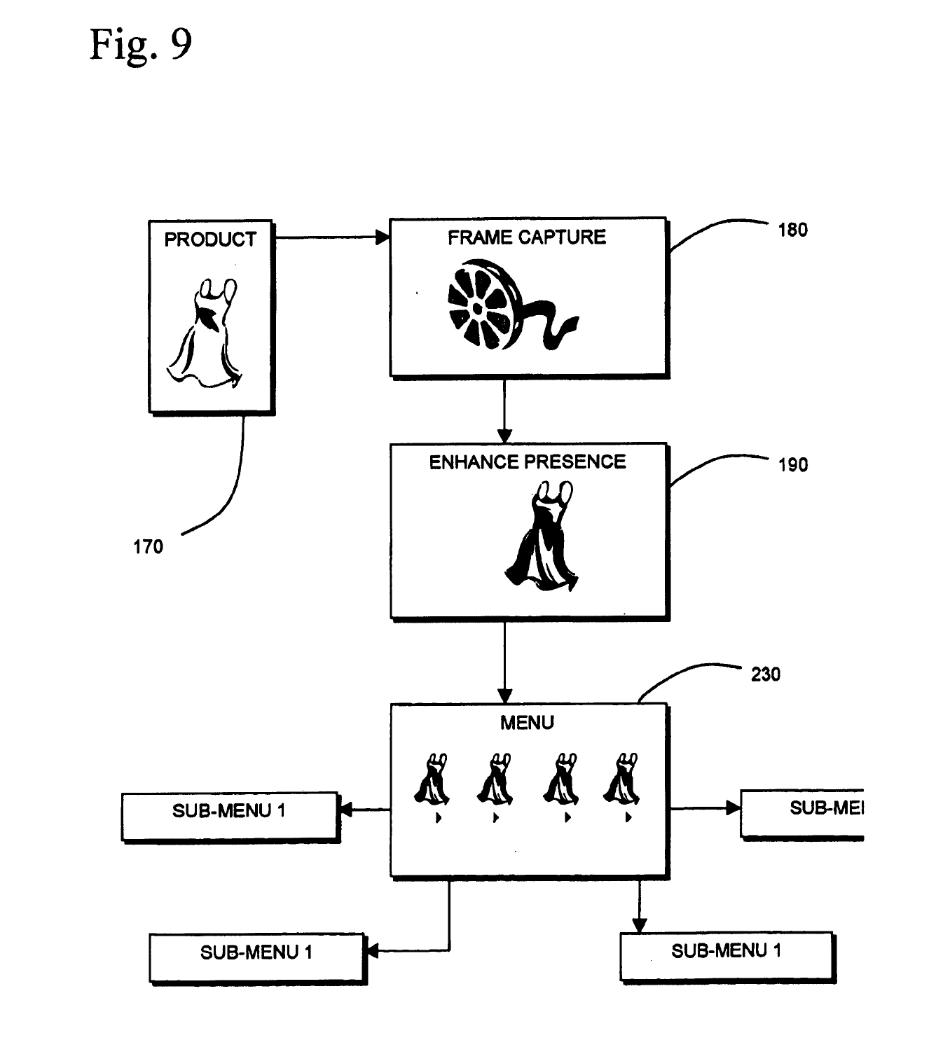

In FIG. 10, an entire video presentation 240 is divided up into three Chapters 1-3. This is commonly done in DVD images to generate scene selections and/or to permit the viewer to skip to different scenes. From each chapter, a motion menu is generated with the video content spanning the associated chapter. The motion menu timeout value is equal to the length of the chapter. Rather than repeating itself, as is normally done for the motion menus, the timeout expiration causes the next motion menu to be displayed. This use of motion menus simulates the unmodified display of the video content in its original state. However, by imbedding the content into a motion menu, the DVD author may now overlay solid, semi-transparent or even transparent buttons over the motion menu. Selecting these buttons permits the viewer to jump to a product menu that is context-sensitive to the particular chapter. For example, if a car chase scene exists in Chapter 1, but not in Chapter 2, a menu button overlaid on Motion Menu 1 would link to Product Menu 1 having information on the automobiles involved in the car chase. However, since the automobile does not appear in Chapter 2, the automobile information does not appear in Product Menu 2. Accordingly, viewers are able to investigate product information substantially contemporaneous with the product's appearance in a video feature.

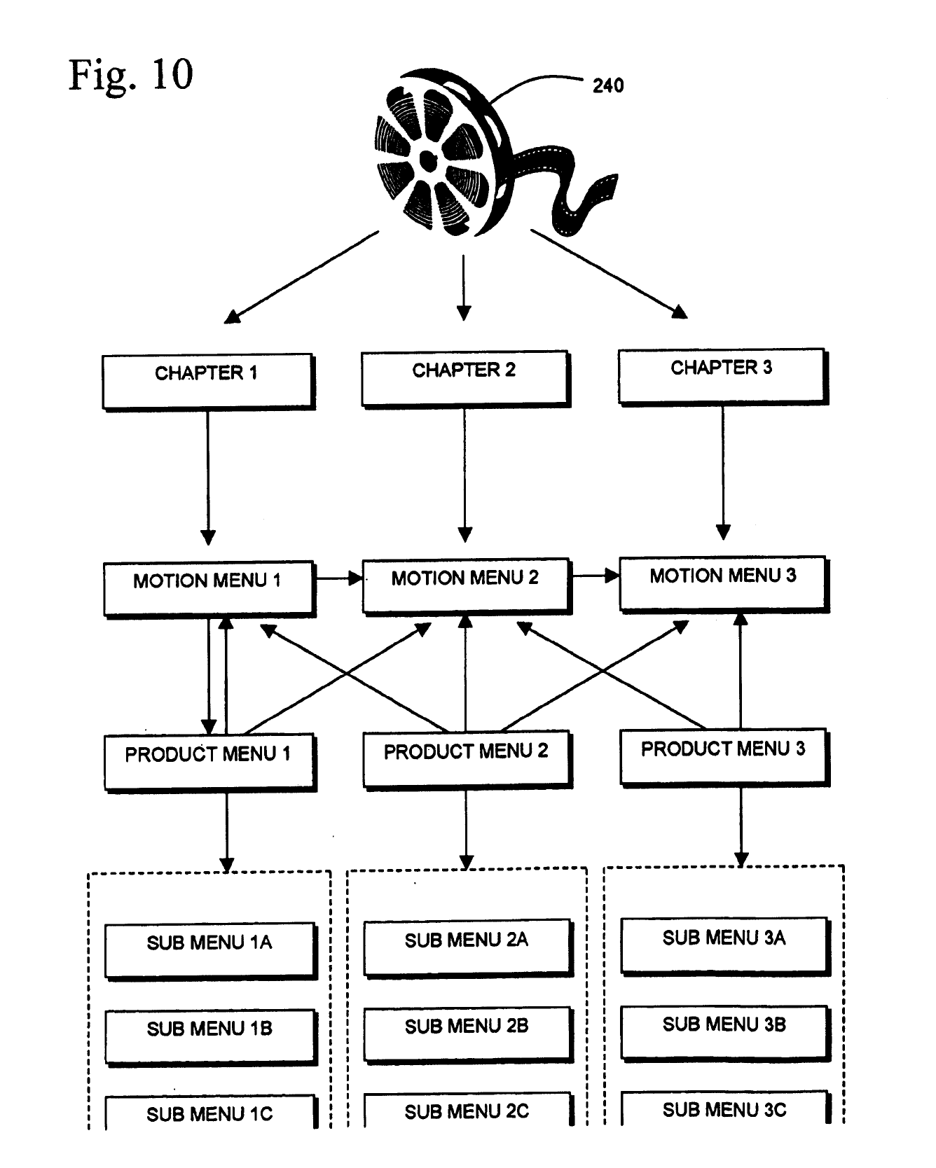

FIG. 11 illustrates an embodiment of the invention wherein timecode and product information is retrieved from client interface 260 over a remote data connection 270 to a database module 250. Should a feature video presentation, such as a movie, contain numerous products, enabling a remote client interface for advertisers to update Information would be desirable and would increase speed and efficiency of generating effecting menu structures for the DVD.

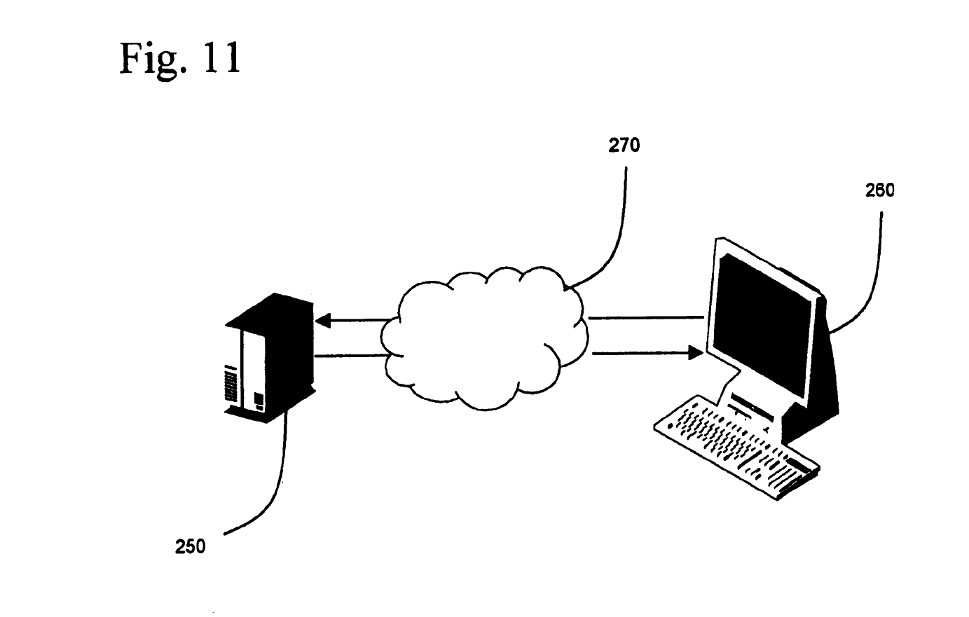

FIG. 12 shows a method of generating pre-production revenue according to the invention. A pre-production bid 280 is announce for soliciting product advertisers and manufacturers. A product placement valuation 290 is calculated from the product time duration 300, the brand name visibility 310, product interaction 320 and actual sales of the DVD 330. Based on the valuation 290 a contract is executed 340 for the placement of the product in the video production.

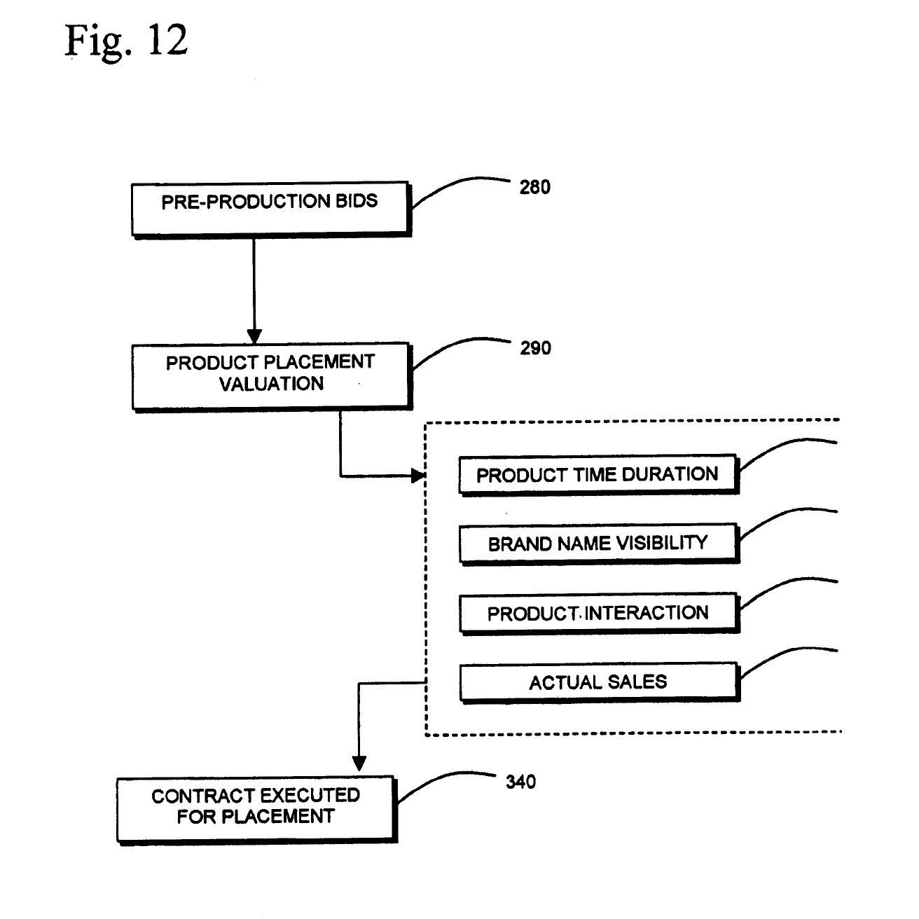

In FIG. 13, a request for a DVD 350 is generated by a viewer. This request may be at a retail establishment, an Internet website or through a call center. The demographic profile 360 of the viewer is generated and targeted advertising is inserted into the DVD 380 prior to the DVD delivery 390 to the viewer. Preferably, the transaction is recorded 380 whereby duplicate advertising content is controlled and optimized to the viewer. The advertising may include services and products, including additional video content. The stored transactions 380 may also be used to generate a profile of what genre of video content the viewer prefers. Responsive to the profile, trailers and promotions for similar content may be inserted 370 prior to delivery 390.

It will be seen that the objects set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween. Now that the invention has been described,

1. A method of presenting purchasing information within a DVD having video content comprising the steps of: identifying product within the video content sought to be sold, capturing at least one frame of the video content showing the product, graphically modifying the frame to enhance the presence of the product, creating a menu interface with the frame, creating a selectable menu button associated with the product, creating a second menu having purchasing information for the product, the second menu displayed responsive to the activation of the button.

2. The method of claim 1 where the selected menu button is defined by an image of the product.

3. The method of claim 1 further comprising the steps recording a time code value of the at least one frame, inserted the modified frame at the time code value and pausing the video content for a predetermine wait loop while the modified frame is displayed.

4. The method of claim 1 further comprising the step of presenting a plurality of modified frames associated with a plurality of different products on at least one menu.

5. The method of claim 4 further comprising the step of generating submenus for the plurality of different products, each submenu displaying additional detail on the associated product.

6. A method of presenting purchasing information with a feature on DVD comprising the steps of:
dividing a feature into a plurality of chapters;
generating a motion menu background of each individual chapter;
inserting at least one product information button over the motion menu background;
responsive to the activation of the at least one product information button linking to a product information menu having data on at least one product in the individual chapter played in the motion menu background.

7. The method of claim 6 further comprising the step of placing a substantially transparent menu button over the motion menu background; setting a timeout value for the motion menu equal to the duration of the clip of the individual chapter whereby upon expiration of the timeout value, the substantially transparent menu button is activated by default to the next chapter in the feature playing through a second motion menu background.

8. A computer software application for authoring video menu structures on a DVD having video content, the software product comprising:
a product database module stored on a computer accessible medium, the product database module comprising at least a product identification data field and a time code data field;
a menu generation module communicatively coupled to the product database module, the menu generation module generating a menu structure responsive to the presence of data fields in the product database module whereby product information contained within a submenu is user-accessible substantially contemporaneous to a product's appearance in the video content.

9. The computer software application of claim 8 further comprising a product grouping module communicatively coupled to the menu generation module whereby products that appear between predetermined time code values are grouped into at least one submenu.

10. The computer software application of claim 9 wherein further comprising a frame capture module communicatively coupled to the product database module whereby at least one still frame showing the product is recorded based on the time code data field.

11. The computer software application of claim 10 wherein the at least one still frame showing the product is inserted in the at least one submenu.

12. The computer software application of claim 9 wherein the product database module comprises a start time code data field and an end time code data field for each product appearing in the video content.

13. The computer software application of claim 12 further comprising a product clip capture module communicatively coupled to the product database module whereby a video clip of the product is extracted from the video content and inserted into the at least one submenu, the span of the video clip defined by the start time code data field and the end time code data field.

14. The computer software application of claim 13 whereby the video clip of the product inserted into the at least one submenu is a user-selectable button, the selection thereof linking to another submenu containing additional product information.

15. The computer software application of claim 9 further comprising a chapter segregation module communicatively coupled to the menu generation module, the chapter segregation module defining the predetermined time code values within which products are grouped whereby each predetermined time code value pair defines a motion menu background, at least two or more user-selectable buttons overlaying a first menu having a motion menu background defined by a first pair of predetermined time code values, responsive to the selection of a first button, the digital versatile disc is advanced chronologically a second menu having a motion menu background defined by a second pair of predetermined time code values, alternatively, upon the selection of a second button the DVD is advanced to a submenu containing product information.

16. The computer software application of claim 15 whereby a first timeout value is generated equal to the length of the first menu, upon expiration of the first timeout value the DVD is advanced to the second menu.

17. The computer software application of claim 8 further comprising a frame capture module communicatively coupled to the product database module whereby at least one still frame showing the product is recorded based on the time code data field.

18. The computer software application of claim 17 further comprising a magnetic lasso selection module communicatively coupled to the frame capture module, the magnetic lasso selection module adapted to select and emphasize the product against the product's background.

19. The computer software application of claim 18 wherein the product's background is gray-scaled while the product is left in color.

20. The computer software application of claim 18 wherein the product's background is blurred while the product is left focused.

21. The computer software application of claim 18 wherein the product's background is solid-filled while the product is left unmodified.

22. The computer software application of claim 8 further comprising a remote client interface adapted to receive product and time code data, the remote client interface communicatively coupled to the product database module.

23. The computer software application of claim 22 wherein the remote client interface further comprises a display of the video content and associated time code data.

24. The computer software application of claim 22 wherein the remote client interface is a web browser.

25. A method of generating pre-production revenue for DVD video content comprising the steps of:
defining a product placement algorithm; and
contracting with at least one or more product distributors to insert the product in the video content according the product placement algorithm.

26. The method of claim 25 wherein the product placement algorithm defines a contract price based on a presence value of the product in the video content.

27. The method of claim 26 wherein the presence value is calculated from an array of presence factors including time duration, brand name visibility, and product interaction.

28. The method of claim 25 wherein the contracting step further comprises a monetary variable based on actual sales of the forthcoming DVD video content.

29. The method of claim 28 wherein the monetary variable further comprises a sales threshold value for contract payments.

30. A method of distributing DVDs having variable advertising content comprising the steps of:
establishing an array of demographic data on an individual viewer;
receiving a request for a video title from the viewer;
automatically inserting advertising content targeted to the demographic data of the viewer;
recording the video title and targeted advertising content on a DVD; and
distributing the disc to the viewer.

31. The method of claim 31 wherein the advertising content recorded on the disc and delivered to the viewer is recorded on a storage means.

32. The method of claim 31 further comprising the step of excluding advertising content previously distributed to the viewer.

33. The method of claim 31 wherein the advertising content is theatrical trailers for motion picture productions.

34. The method of claim 33 further comprising the steps of:
retrieving past requests from the storage means;
categorizing the type of requests into a genre;
selecting an array of related video titles within the genre; and
recording theatrical trailers to the genre with the video title on the DVD.

35. The method of claim 34 further comprising the step of excluding related theatrical trailers previously distributed to the viewer from the array.
